(19) United States
(12) Patent Application Publication
(10) Pub. No.: US 2014/0048107 A1
(43) Pub. Date: Feb. 20, 2014

(54) Method Of Cleaning

(71) Applicants: Marine Cabirol, Ludwigshafen (DE); Claudia Schmaelzle, Ludwigshafen (DE); Lucia Krubasik, Ludwigshafen (DE); Jorg Pflug, Ludwigshafen (DE)

(72) Inventors: Marine Cabirol, Ludwigshafen (DE); Claudia Schmaelzle, Ludwigshafen (DE); Lucia Krubasik, Ludwigshafen (DE); Jorg Pflug, Ludwigshafen (DE)

(73) Assignee: RECKITT BENCKISER N.V., Hoofddorp (NL)

(21) Appl. No.: 13/990,415

(22) PCT Filed: Nov. 28, 2011
(86) PCT No.: PCT/GB2011/052341

§ 371 Date: Jul. 9, 2013

(30) Foreign Application Priority Data
Nov. 30, 2010 (GB) 1020247.1

(51) Int. Cl. C11D 11/00

(52) U.S. Cl. CPC C11D 11/0023; C11D 11/0058
USPC 134/25.2; 134/34

(57) ABSTRACT

The invention comprises a method of carrying out machine dishwashing, using a cleaning composition, the method comprising delivery of the cleaning composition into the machine, characterised in that the cleaning composition is delivered to the machine from a pressurised aerosol canister as a foam or as a foam precursor which forms foam before the machine is operated.

The invention relates to a method of cleaning, in particular to a method of cleaning a kitchenware article, in a machine dishwasher.

Machine dishwashing is convenient and labour saving but there are few choices for the consumer, in terms of dishwashing composition formats. There are bulk sources of dishwashing composition, namely liquids and powders. There are unit dose sources, namely tablets and “pouches”, i.e. gels, powders or liquids wrapped in water-soluble polyvinyl alcohol film.

Each of these formats has its disadvantages. Liquids and loose powders are not convenient and may be spilt. Tablets usually have to be unwrapped, bringing the composition into contact with the hands. The water-soluble polyvinyl alcohol film used as the outside of pouches means that there are some limitations on the composition which can be used, inside the pouch. Moreover the films are prone to deterioration in humid environments and may start to dissolve when picked up using wet hands.

Aerosol dispensers for foam household chemical products are known from e.g. WO 2005/037970, WO 2007/111962 and DE 10 2009 001 493. Also dishwashing kits comprising a container with a foam generating dispenser and a dishwashing composition within the container are known from WO 2004/078903.

It is an object of the present invention to provide an improved or alternative, effective, dishwashing method, and thereby increase the choice available to the consumer. It is a further or alternative object of the present invention to minimise the risk of contact between the dishwashing product, whether chemical agents thereof or a water soluble film around them, and the user.

According to a first aspect of the present invention there is provided a method of carrying out machine dishwashing, using a cleaning composition, the method comprising delivery of the cleaning composition into the machine, characterised in that the cleaning composition is delivered to the machine from a pressurised aerosol canister as a foam or as a foam precursor which forms foam before the machine is operated.

A pressurised aerosol canister is an apt delivery means for the cleaning composition because it allows for accurate delivery of that cleaning composition. Using the pressurised aerosol canister dosing may be done accurately and without wastage of the cleaning composition.

The cleaning composition, when it is inside the pressurised aerosol canister, is suitably a liquid or a gel. Suitably it contains a propellant. When permitted to leave the canister it forms a foam, either immediately or after an interval.

The cleaning composition can be delivered to the dishwashing machine and especially into its dosing compartment or directly into the main chamber of the dishwashing machine as a foam. It may be carried into the chamber on a kitchenware article and is preferably delivered as a foam. The kitchenware article may be an article which is soiled by a food soil and the cleaning composition may then perform the dual function of pre-treating the food soil and, later, being the main wash cleaning composition.

The cleaning composition may be delivered into the dishwashing machine (which includes the dosing compartment and the main chamber) as a foam. The cleaning composition may forms a foam immediately on exiting the canister or after exiting the canister, but before it enters the dishwashing machine.

In an alternative embodiment the cleaning composition is still in the form of a liquid or gel when it enters the dishwashing machine, and it subsequently foams.

The cleaning composition may undergo two stages of foaming: one caused or substantially caused by the pressure drop on leaving the canister and the other caused or substantially caused by loss of propellant from within the cleaning composition.

In a further alternative embodiment the cleaning composition is already a foam when it enters the dishwashing machine, but subsequently undergoes a second stage of foaming, inside the dishwashing machine.

Foaming when the cleaning composition exits the canister or soon after it exits the canister, before it enters the dishwashing machine, may be caused by the pressure release on exiting. Foaming which continues inside the dishwashing machine may be caused by the escape of propellant from the cleaning composition. Nevertheless the physical attributes of the foam may be same, however formed.

Embodiments in which foaming (including further foaming) take place inside the dishwashing machine are believed to be particularly advantageous because the dynamic process of foam formation in situ is believed to promote intimate contact between the chemical cleaning agents carried by the foam, and food soils on kitchenware articles.

The foam may have the quality that it forms, and then dies away relatively quickly, for example within ten minutes of forming. Alternatively it may be a longer-lasting foam, and may even be a foam which is sufficiently persistent to remain as a foam for an extended period, before the washing operation of the dishwashing machine. For example the foam may persist for at least two hours, preferably for at least four hours, and in some embodiments, for at least eight hours.

In some embodiments the foam may be a coarse foam or a weak foam. In some embodiments the foam may be a fine foam or a strong foam, for example a crème or mousse.

The foam is preferably able to cling to a vertical or inclined surface.

The foam may be self-standing.

Preferably a cleaning composition which foams, or foams further, after exiting the canister, has finished its foaming within 20 minutes of exiting, preferably within 10 minutes, preferably within 5 minutes, preferably within 2 minutes, and most preferably within 1 minute.

Preferably the expansion coefficient for a foam or foam precursor is up to 400%, preferably up to 200%, preferably up to 100%, preferably up to 50%, and most preferably up to 30%. Preferably the expansion coefficient is at least 5%, preferably at least 10%. By expansion coefficient we refer to the ratio of the volume of the fully expanded foam or foam precursor cleaning composition to when unfoamed.

The cleaning composition preferably has a pH in the range 7-13, preferably 7-10.

The cleaning composition preferably contains up to 80% wt water and up to 8% wt propellant, and has one or more of the following components in the amount stated:
5-70% wt builder(s),
0.1-10% wt surfactant(s),
0.01-5% wt, anti-corrosion agent(s),
0.1-20% wt performance polymer(s), preferably sulphonated polymer(s),
0.1-5% wt enzyme(s).

Suitable components of a cleaning composition used in the present invention are as follows:

### Builders

The cleaning composition may also comprise conventional amounts of detergent builders which may be either phosphorous based (e.g. STPP) or non-phosphorous based, or even a combination of both types. Suitable builders are well known in the art. Non-phosphorous builders are preferred.

Non-phosphorous based builder may be organic molecules with carboxylic group(s), amino acid based compound or a succinic acid or succinate based compound.

Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred.

Preferably the total amount of builder present in the compositions of the invention is an amount of at least 5% wt, preferably at least 10% wt, more preferably at least 20% wt, and most preferably at least 25% wt.

Preferably the total amount of builder present in the compositions of the invention is an amount of up to 70% wt, preferably up to 60% wt, more preferably up to 50% wt, preferably up to 40% wt, and most preferably up to 32% wt.

### Surfactants

The cleaning compositions of the invention may contain surfactants. Preferred surfactants are anionic surfactants and non-ionic surfactants. Many such surfactants are described in Kirk Othmer's Encyclopedia of Chemical Technology, 3rd Ed., Vol. 22, pp. 360-379, “Surfactants and Detersive Systems”.

A preferred class of nonionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

Preferably the surfactant(s) is/are present in the cleaning compositions used in the invention in an amount of from 0.1% wt, more preferably from 0.2% wt, most preferably from 0.5% wt.

Preferably the surfactant(s) is/are present in the compositions used in the invention in an amount of up to 10% wt, preferably up to 5% wt, most preferably up to 3% wt.

Anti-corrosion agents

It is known to include a source of multivalent ions in cleaning compositions, and in particular in automatic dishwashing compositions, for technical and/or performance reasons. For example, multivalent ions and especially zinc and/or manganese ions have been included for their ability to inhibit corrosion on metal and/or glass. Zinc sulphate is a preferred compound for this purpose.

Any conventional amount of multivalent ions/multivalent ions source may be included in the cleaning compositions used in the invention. However, it is preferred that the multivalent ions are present in an amount of from 0.01% wt, preferably of from 0.05% wt, preferably of from 0.1% wt. It is preferred that the multivalent ions are present in an amount of up to 5% wt, preferably up to 3% wt, preferably up to 2.5% wt.

### Performance Polymers

Polymers intended to improve the cleaning performance of the cleaning compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof.

When a sulfonated polymer is present, it is preferably present in the cleaning compositions in an amount of at least 0.1% wt, preferably at least 0.5% wt, more preferably at least 1% wt, and most preferably at least 2% wt. A sulfonated polymer, when present, is preferably present in the compositions in an amount of up to 20% wt, preferably up to 10% wt, more preferably up to 5% wt.

### Enzymes

The cleaning compositions of the invention may comprise one or more enzymes. It is preferred that the enzyme is selected from protease, lipase, amylase, cellulase and peroxidase enzymes.

Desirably enzyme(s) is/are present in the cleaning compositions in an amount of from 0.01% wt, especially of from 0.1% wt, most preferably of from 0.2% wt. Desirably enzyme(s) is/are present in the composition in an amount of up to 10% wt, preferably up to 7% wt, most preferably up to 5% wt.

Bleaching compounds

Any type of bleaching compound conventionally used in dishwashing compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

When a bleaching compound is present in the cleaning composition it is suitably present in an amount up to 40% wt, preferably up to 20% wt, preferably up to 10% wt, preferably up to 5% wt.

A bleaching compound may be protected from another component which it may degrade, and/or which may cause its own degradation. For examples a bleaching compound and an enzyme may be protected from each other, by physical separation. Physical separation may, for example, take the form of a coating around one or both such component, or by providing such components in separate compartments within the canister.

### Other Components

The cleaning compositions of the invention may also comprise minor, conventional amounts of thickeners, wetting agents, perfumes, preservatives and/or colourants. Such ingredients are typically present in amounts of up to 2% wt.

The cleaning composition may suitably comprise water. Suitably the water content is not more than 80% wt, preferably not more than 65% wt, preferably not more than 45% wt, preferably not more than 30% wt, and in some preferred embodiments not more than 20% wt.

The cleaning composition when in the canister preferably contains, mixed within the composition, a propellant. Suitably such a propellant is a gaseous hydrocarbon, most preferably butane. Such a propellant preferably constitutes at least 0.2% wt of the composition, preferably at least 0.5% wt, and most preferably at least 0.8% wt. Preferably such a propellant constitutes not more than 8% wt of the composition, preferably not more than 4% wt, more preferably not more than 2% wt.

Suitably the aerosol canister will contain a bag on valve system, and the composition, containing the aforementioned propellant, is provided within the bag, and open to the valve, and thus able to exit the canister when the valve is open. This process is aided by a second propellant, inside the canister but outside the bag. Typically this second propellant is compressed air or nitrogen. Two (or more) bags may be provided inside the canister when components are best kept apart, as described above.

All of the numerical definitions given above for amounts of a component represent the total amount of such components, when more than one is present e.g. when there are two types of enzyme.

% wt values given herein mean percentage by weight of the specified component, as a percentage of the total weight of the composition unless otherwise specified.

Preferably the cleaning composition does not contain any particulate components.

Preferably the cleaning composition does not contain any sulphonate or alkyl sulphosuccinate surfactants.

Most preferably the cleaning composition contains a non-ionic surfactant but no anionic surfactant or other surfactant type.

The cleaning composition used for the dishwashing step may also be used as a pre-cleaning composition for pre-treating food soils, especially stubborn or burnt-on food soils by being applied to kitchenware to combat food soils. In this embodiment a first charge of the cleaning composition is used as a pre-cleaning composition for pre-treating food soils prior to dishwashing and a second charge of the composition could then be used for the dishwashing cycle. Alternatively one single charge of the composition could be used for pre-treatment and the machine dishwashing cycle, with the pre-treated kitchenware article being used to deliver the cleaning composition to the dishwasher, to perform the function of a main wash cleaning composition. Where the composition is used as a pre-cleaning composition the disclosures herein for the cleaning composition apply equally to the pre-cleaning composition.

In such a pre-treatment step the cleaning composition may be applied to substantially the entire cooking surface of the kitchenware article. By cooking surface we mean the surface of the kitchenware article which is liable to come into contact with food.

Alternatively, in such a pre-treatment step the cleaning composition is applied to a part only of the cooking surface of the kitchenware article; preferably locally onto a part of the cooking surface which is heavily soiled by food.

Preferably such a pre-treatment step includes a dwell time, after the cleaning composition is applied to the kitchenware article, and lasting until the commencement of the washing step. Preferably the dwell time is at least 5 minutes, preferably at least 15 minutes, more preferably at least 30 minutes, more preferably at least 1 hour, more preferably at least 8 hours, and more preferably at least 12 hours. Preferably the dwell time is up to 30 hours, preferably up to 24 hours.

Good results have been achieved by use of the present invention. Kitchenware articles are cleaned effectively and the delivery format is clean and accurate.

If wished the aerosol canister could provide metered delivery, but unmetered delivery will often be adequate, due the control the user has over delivery, from an aerosol canister. The user may be provided with instructions for usage. The instructions may indicate a time for aerosol delivery, or a fill level into the dosing compartment or a dosing cup which is provided. The specified fill level may be expected to take account of the expansion coefficient mentioned above.

In accordance with a second aspect of the present invention there is provided the use, in machine dishwashing, of a foam composition as defined herein, delivered into the dishwasher. A “foam composition” here means a foam, or a foaming or foamable composition.

Preferred features of the use of the second aspect are as given above for the method of the first aspect.

The invention will now be further described, by way of example, with reference to the following embodiment.

The following three gel formulations were prepared.

| Relative % | Relative % | Relative % | Function |
|---|---|---|---|
| 0.200 | 0.200 | 0.200 | Dye |
| 0.300 | 0.300 | 0.300 | Preservative |
| 1.600 | 1.600 | 1.600 | Additives |
| 0.100 | 0.100 | 0.100 | Corrosion Inhibitor |
| 0.600 | 0.600 | 0.600 | Thickener |
| 2.500 | 2.500 | 2.500 | Surfactant |
| 2.700 | 2.700 | 2.700 | Sulfonated Polymer |
| 30.000 | 30.000 | 30.000 | Complexing agent (GLDA) |
| 0.500 | 0.500 | 0.500 | Amylase Enzyme |
| 4.000 | 4.000 | 4.000 | Protease Enzyme |
| 0.300 | 0.300 | 0.300 | Fragrance |
| 1.961 | 1.478 | 0.990 | Propellant (Butane-40) |
| 55.239 | 55.722 | 56.210 | Solvent (water) |

GLDA = Glutamic acid, N,N-diacetic acid, tetrasodium salt

These cleaning compositions were loaded into respective aerosol canisters of the bag-in-canister type. An inert gas under pressure occupied the space between the bag, containing the respective composition, and the canister walls.

The compositions were tested in a range of tests. The tests involved different food soils, and dishwashing cycles. The compositions were emitted from the canisters as a gel which quickly (within 1 minute) formed a mousse-like but low-level foam (foam coefficient of approximately 40%). Delivery was sometimes into the dosing compartment of the dishwashing machine, sometimes into the main chamber of the dishwasher, and sometimes onto a soiled kitchenware article which was then placed in the dishwasher, the composition thus functioning as a pre-treatment composition and as a main wash composition. This by-passing of the dosing compartment was done when the cycle selected had no pre-wash and dishwashing performance was excellent.

1. A method of washing with a machine comprising:
delivering a cleaning composition into a machine from a pressurized source; and
enabling the cleaning composition to foam before the machine is operated.

2. The method as claimed in claim 1, the chemical composition having an unfoamed condition and a foamed condition, wherein the expansion co-efficient of the foamed cleaning composition to when unfoamed is up to 400%.

3. (canceled)

4. The method as claimed in claim 1, wherein the cleaning composition has a pH in the range of from 7 to 13.

5. The method as claimed in claim 1, wherein the cleaning composition comprises:
up to 80% wt water;
up to 8% wt propellant; and
one or more of the following components:
5-70% wt builder;
0.1-10% wt surfactant;
0.01-5% wt anti-corrosion agent;
0.1-20% wt performance polymer; and
0.1-5% wt enzyme.

6. The method as claimed in claim 13, wherein the canister contains a bag which contains the cleaning composition which includes a propellant, and the canister contains a second propellant around the bag.

7. (canceled)

8. The method as claimed in claim 1, wherein the cleaning composition is in the form of a liquid or gel when it enters the machine, and it subsequently foams.

9. The method as claimed in claim 13, wherein the cleaning composition undergoes two stages of foaming: one substantially caused by the pressure drop on leaving the canister and the other substantially caused by loss of propellant from within the cleaning composition.

10. The method as claimed in claim 1, further comprising pre-cleaning an article to be cleaned in the machine with the cleaning composition.

11. The method as claimed in claim 10, wherein a first charge of the cleaning composition is used as a pre-cleaning composition for pre-treating food soils on the article prior to washing in a dishwashing machine, and a second charge of the same cleaning composition is used for a dishwashing cycle of the dishwashing machine.

12. The method as claimed in claim 10, wherein the machine is a dishwashing machine having a dishwashing cycle, and the article is a kitchenware article, and wherein a single charge of the cleaning composition is used for pre-treatment and the machine dishwashing cycle, a pre-treated kitchenware article being used to deliver the cleaning composition to the dishwasher, to perform the function of a main wash cleaning composition.

13. The method of claim 1, wherein the pressurized source comprises a pressurized aerosol canister.

14. The method of claim 1, wherein delivering the cleaning composition into a machine comprises delivering the cleaning composition as a foam.

15. The method of claim 1, wherein delivering the cleaning composition into a machine comprises delivering the cleaning composition as a foam precursor.

16. The method as claimed in claim 1, the chemical composition having an unfoamed condition and a foamed condition, wherein the expansion co-efficient of the foamed cleaning composition to when unfoamed is up to 200%.

17. The method as claimed in claim 1, the chemical composition having an unfoamed condition and a foamed condition, wherein the expansion co-efficient of the foamed cleaning composition to when unfoamed is up to 100%.

18. The method as claimed in claim 1, the chemical composition having an unfoamed condition and a foamed condition, wherein the expansion co-efficient of the foamed cleaning composition to when unfoamed is up to 50%.

19. The method as claimed in claim 1, the chemical composition having an unfoamed condition and a foamed condition, wherein the expansion co-efficient of the foamed cleaning composition to when unfoamed is up to 30%.

20. The method as claimed in claim 1, the chemical composition having an unfoamed condition and a foamed condition, wherein the expansion co-efficient of the foamed cleaning composition to when unfoamed is at least 5%.

21. The method as claimed in claim 1, wherein the cleaning composition comprises 0.1 20% wt sulphonated polymer.
